(19) United States
(12) Patent Application Publication
(10) Pub. No.: US 2014/0204075 A1
(43) Pub. Date: Jul. 24, 2014

(54) Clock Control Circuit, Driving Circuit and Liquid Crystal Display Device

(71) Applicants: Yong Zhang, Shenzhen City (CN); Liang-chan Liao, Shenzhen City (CN)

(72) Inventors: Yong Zhang, Shenzhen City (CN); Liang-chan Liao, Shenzhen City (CN)

(73) Assignee: Shenzhen China Star Optoelectronics Technology Co., Ltd., Shenzhen, Guangdong (CN)

(21) Appl. No.: 13/813,435

(22) PCT Filed: Jan. 25, 2013
(86) PCT No.: PCT/CN2013/070961

§ 371 Date: Jan. 31, 2013

(30) Foreign Application Priority Data
Jan. 23, 2013 (CN) 201310024963.0

(51) Int. Cl. G09G 3/36; G06F 1/04

(52) U.S. Cl. CPC G09G 3/36; G06F 1/04
USPC 345/214

(57) ABSTRACT

The present invention provides a clock control circuit, driving circuit and liquid crystal display device. The clock control circuit includes internal clock module, signal receiving module, selection module, detection module and control module. The detection module determines whether an external input signal is valid clock signal; if so, the control module controls the selection module to select the external input signal for outputting; otherwise, select the internal clock signal for outputting. As such, the present invention avoids condition of abnormal displaying of the LCD when no external input signal is present so as to improve the displaying quality of the LCD.

### BACKGROUND OF THE INVENTION

1. Field of the Invention

The present invention relates to the field of liquid crystal displaying techniques, and in particular to a clock control circuit, driving circuit and liquid crystal display device.

2. The Related Arts

In liquid crystal display device, the clock control circuit is for supplying clock signals to the source driving circuit and gate driving circuit, wherein the clock signals supplied by the clock control circuit comprises internal clock signal and external clock signal. Specifically, when there is inputted external clock signal, the clock control circuit supplies the external clock signal: and when there is no inputted external clock signal, the clock control circuit supplies the internal clock signal.

However, if an offset occurs in the clock control circuit during manufacturing, or the threshold voltage (Vth) of the clock control circuit changes after the temperature test during the reliability analysis (RA), the clock control circuit will mistake the noise signal as the external clock signal when no external clock signal input comes in but only the external noise signal is present. As a result, the noise signal will be provided to the source driving circuit or gate driving circuit as the external clock signal. Because the frequency and voltage of the noise signal are unstable, abnormal display will occur for liquid crystal display device.

### SUMMARY OF THE INVENTION

The technical issue to be addressed by the present invention is to provide a dock control circuit, driving circuit and liquid crystal display device, able to determine accurately whether the external input signal is a valid clock signal so as to avoid abnormal display when no external clock signal is inputted to improve the displaying quality of the liquid crystal display device.

The present invention provides a clock control circuit, which comprises: an internal clock module, a signal receiving module, a selection module, a detection module and a control module, wherein the internal clock module being configured to generate internal clock signal; the signal receiving module being configured to receive external input signal and transmit the external input signal to the detection module; the detection module being configured to determine whether the external input signal being a valid clock signal and transmit the determination to the control module; and the control module being configured to control the selection module to select the external input signal for outputting when the determination from the detection module being yes and to select the internal clock signal for outputting when the determination from the detection module being no.

According to a preferred embodiment of the present invention, the detection module is a pulse width detection module, which comprises a timing unit and a comparison unit; wherein the timing unit is for measuring the interval between two adjacent edges with the same direction in the external input signal; the comparison unit predefines a time threshold range and determines whether the interval is within the time threshold range; when the result is yes, the control module determines the external input signal is valid clock signal and controls the selection module to select the external input signal for outputting; when the result is no, the control module determines the external input signal is invalid clock signal and controls the selection module to select the internal clock signal for outputting.

According to a preferred embodiment of the present invention, the pulse width detection module comprises a first comparison unit, a second comparison unit and a logic operation unit; wherein the first comparison unit predefines a first boundary value of the time threshold range and compares the interval with the first boundary value to obtain a first comparison result; the second comparison unit predefines a second boundary value of the time threshold range and compares the interval with the second boundary value to obtain a second comparison result; the logic operation unit performs logic operation on the first comparison result and the second comparison result; based on the logic operation result of the logic operation unit, the control module controls the selection module to select either the external input signal or the internal clock signal for outputting.

According to a preferred′ embodiment of the present invention, when the logic operation result is 1, the control module determines the external input signal is valid clock signal and controls the selection module to select the external input signal for outputting; when the logic operation result is 0, the control module determines the external input signal is invalid clock signal and controls the selection module to select the internal clock signal for outputting; alternatively, when the logic operation result is 1, the control module determines the external input signal is invalid clock signal and controls the selection module to select the internal clock signal for outputting; when the logic operation result is 0, the control module determines the external input signal is valid clock signal and controls the selection module to select the external input signal for outputting.

According to a preferred embodiment of the present invention, the first boundary value and the second boundary value are both a multiple of the interval between two adjacent edges with the same direction of the internal clock signal.

According to a preferred embodiment of the present invention, the detection module is a frequency detection module, which comprises: a transformation unit and a comparison unit; wherein the transformation unit is for transforming the frequency of the external input signal into the voltage of the external input signal; the comparison unit predefines a voltage threshold range and determines whether the voltage is within the voltage threshold range; when the result is yes, the control module determines the external input signal is valid clock signal and controls the selection module to select the external input signal for outputting; when the result is no, the control module determines the external input signal is invalid clock signal and controls the selection module to select the internal clock signal for outputting.

According to a preferred embodiment of the present invention, the frequency detection module comprises a first comparison unit, a second comparison unit and a logic operation unit; wherein the first comparison unit predefines a first boundary value of the voltage threshold range and compares the voltage with the first boundary value to obtain a first comparison result; the second comparison unit predefines a second boundary value of the voltage threshold range and compares the voltage with the second boundary value to obtain a second comparison result; the logic operation unit performs logic operation on the first comparison result and the second comparison result; based on the logic operation result of the logic operation unit, the control module controls the selection module to select either the external input signal or the internal clock signal for outputting.

According to a preferred embodiment of the present invention, when the logic operation result is 1, the control module determines the external input signal is valid clock signal and controls the selection module to select the external input signal for outputting; when the logic operation result is 0, the control module determines the external input signal is invalid clock signal and controls the selection module to select the internal clock signal for outputting; alternatively, when the logic operation result is 1, the control module determines the external input signal is invalid clock signal and controls the selection module to select the internal clock signal for outputting; when the logic operation result is 0, the control module determines the external input signal is valid clock signal and controls the selection module to select the external input signal for outputting.

According to a preferred embodiment of the present invention, when the control module controls the selection module to select the internal clock signal for outputting, the clock control circuit generates a reset signal.

The present invention provides a driving circuit, which comprises: a source driving circuit, a gate driving circuit and a clock control circuit; wherein the clock control circuit supplying clock signal to the source driving circuit and the gate driving circuit respectively; the source driving circuit supplying a data signal to a pixel array based on the clock signal; the gate driving circuit supplying a scan signal to the pixel array based on the clock signal; wherein the clock control circuit comprising: an internal clock module, a signal receiving module, a selection module, a detection module and a control module, wherein the internal clock module being configured to generate internal clock signal; the signal receiving module being configured to receive external input signal and transmit the external input signal to the detection module; the detection module being configured to determine whether the external input signal being a valid clock signal and transmit the determination to the control module; and the control module being configured to control the selection module to select the external input signal for outputting when the determination from the detection module being yes and to select the internal clock signal for outputting when the determination from the detection module being no.

According to a preferred embodiment of the present invention, the detection module is a pulse width detection module, which comprises a timing unit and a comparison unit; wherein the timing unit is for measuring the interval between two adjacent edges with the same direction in the external input signal; the comparison unit predefines a time threshold range and determines whether the interval is within the time threshold range; when the result is yes, the control module determines the external input signal is valid clock signal and controls the selection module to select the external input signal for outputting; when the result is no, the control module determines the external input signal is invalid clock signal and controls the selection module to select the internal clock signal for outputting.

According to a preferred embodiment of the present invention, the pulse width detection module comprises a first comparison unit, a second comparison unit and a logic operation unit; wherein the first comparison unit predefines a first boundary value of the time threshold range and compares the interval with the first boundary value to obtain a first comparison result; the second comparison unit predefines a second boundary value of the time threshold range and compares the interval with the second boundary value to obtain a second comparison result; the logic operation unit performs logic operation on the first comparison result and the second comparison result; based on the logic operation result of the logic operation unit, the control module controls the selection module to select either the external input signal or the internal clock signal for outputting.

According to a preferred embodiment of the present invention, the detection module is a frequency detection module, which comprises; a transformation unit and a comparison unit; wherein the transformation unit is for transforming the frequency of the external input signal into the voltage of the external input signal; the comparison unit predefines a voltage threshold range and determines whether the voltage is within the voltage threshold range; when the result is yes, the control module determines the external input signal is valid clock signal and controls the selection module to select the external input signal for outputting; when the result is no, the control module determines the external input signal is invalid clock signal and controls the selection module to select the internal clock signal for outputting.

According to a preferred embodiment of the present invention, the frequency detection module comprises a first comparison unit, a second comparison unit and a logic operation unit; wherein the first comparison unit predefines a first boundary value of the voltage threshold range and compares the voltage with the first boundary value to obtain a first comparison result; the second comparison unit predefines a second boundary value of the voltage threshold range and compares the voltage with the second boundary value to obtain a second comparison result; the logic operation unit performs logic operation on the first comparison result and the second comparison result; based on the logic operation result of the logic operation unit, the control module controls the selection module to select either the external input signal or the internal clock signal for outputting.

The present invention provides a liquid crystal display device, which comprises: a pixel array and a driving circuit; the driving circuit further comprising: a source driving circuit, a gate driving circuit and a clock control circuit; wherein the clock control circuit supplying clock signal to the source driving circuit and the gate driving circuit respectively; the source driving circuit supplying a data signal to a pixel array based on the clock signal; the gate driving circuit supplying a scan signal to the pixel array based on the clock signal; wherein the clock control circuit comprising: an internal clock module, a signal receiving module, a selection module, a detection module and a control module, wherein the internal clock module being configured to generate internal clock signal; the signal receiving module being configured to receive external input signal and transmit the external input signal to the detection module; the detection module being configured to determine whether the external input signal being a valid clock signal and transmit the determination to the control module; and the control module being configured to control the selection module to select the external input signal for outputting when the determination from the detection module being yes and to select the internal clock signal for outputting when the determination from the detection module being no.

According to a preferred embodiment of the present invention, the detection module is a pulse width detection module, which comprises a timing unit and a comparison unit; wherein the timing unit is for measuring the interval between two adjacent edges with the same direction in the external input signal; the comparison unit predefines a time threshold range and determines whether the interval is within the time threshold range; when the result is yes, the control module determines the external input signal is valid clock signal and controls the selection module to select the external input signal for outputting; when the result is no, the control module determines the external input signal is invalid clock signal and controls the selection module to select the internal clock signal for outputting.

According to a preferred embodiment of the present invention, the pulse width detection module comprises a first comparison unit, a second comparison unit and a logic operation unit; wherein the first comparison unit predefines a first boundary value of the time threshold range and compares the interval with the first boundary value to obtain a first comparison result; the second comparison unit predefines a second boundary value of the time threshold range and compares the interval with the second boundary value to obtain a second comparison result; the logic operation unit performs logic operation on the first comparison result and the second comparison result; based on the logic operation result of the logic operation unit, the control module controls the selection module to select either the external input signal or the internal clock signal for outputting.

According to a preferred embodiment of the present invention, the detection module is a frequency detection module, which comprises; a transformation unit and a comparison unit; wherein the transformation unit is for transforming the frequency of the external input signal into the voltage of the external input signal; the comparison unit predefines a voltage threshold range and determines whether the voltage is within the voltage threshold range; when the result is yes, the control module determines the external input signal is valid clock signal and controls the selection module to select the external input signal for outputting; when the result is no, the control module determines the external input signal is invalid clock signal and controls the selection module to select the internal clock signal for outputting.

According to a preferred embodiment of the present invention, the frequency detection module comprises a first comparison unit, a second comparison unit and a logic operation unit; wherein the first comparison unit predefines a first boundary value of the voltage threshold range and compares the voltage with the first boundary value to obtain a first comparison result; the second comparison unit predefines a second boundary value of the voltage threshold range and compares the voltage with the second boundary value to obtain a second comparison result; the logic operation unit performs logic operation on the first comparison result and the second comparison result; based on the logic operation result of the logic operation unit, the control module controls the selection module to select either the external input signal or the internal clock signal for outputting.

The efficacy of the present invention is that to be distinguished from the state of the art. The clock control circuit of the present invention uses the signal receiving module to receive external input signal and transmits the external input signal to the detection module; the detection module determines whether the external input signal is valid clock signal and transmits the determination result to the control module: when the determination result is yes, the control module controls the selection module to select the external input signal for outputting, and when the determination result is no, the control module controls the selection module to select the internal clock signal for outputting. As such, the present invention first determines whether the external input signal is a valid clock signal when receiving the external input signal. When determined to be valid clock signal, the external input signal will be outputted: otherwise, the internal clock signal will be outputted. As a result, the present invention can avoid abnormal display when no external clock signal is inputted and the noise signal is mistaken as clock signal, so as to improve the displaying quality of the liquid crystal display device.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the

### DRAWINGS

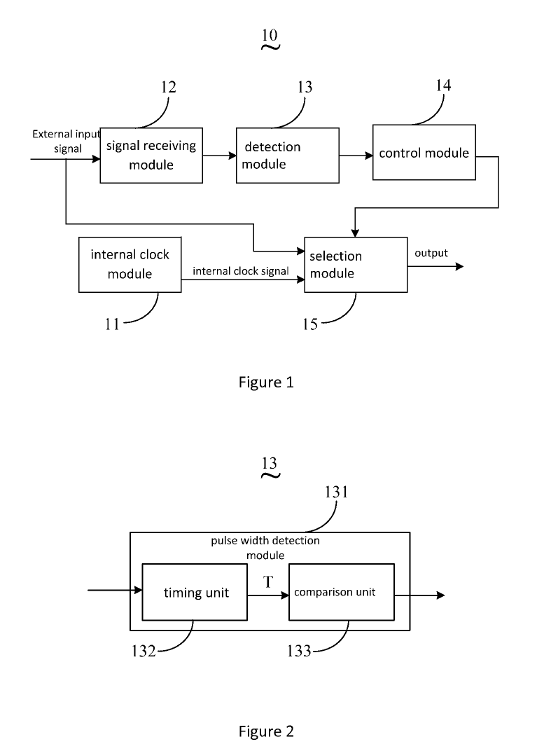

FIG. 1 is a schematic view showing the structure of a clock control circuit of an embodiment of the present invention;

FIG. 2 is a schematic view showing the structure of the detection module shown in FIG. 1;

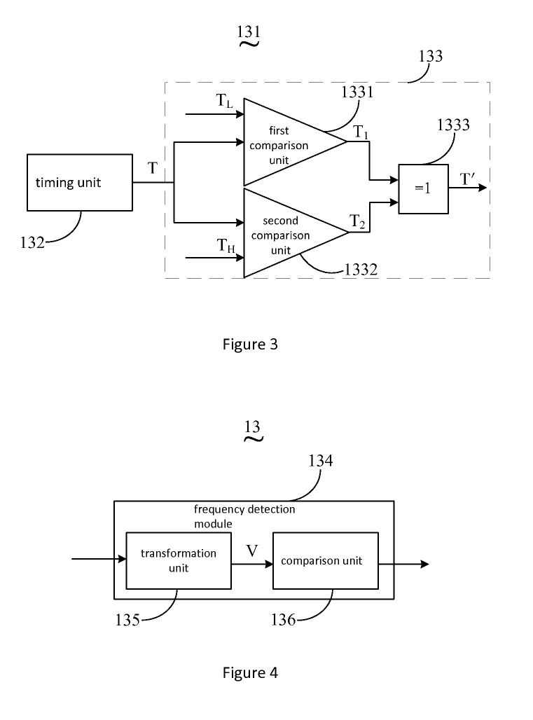

FIG. 3 is a schematic view showing the specific structure of the pulse width detection module;

FIG. 4 is a schematic view showing another structure of the detection module shown in FIG. 1;

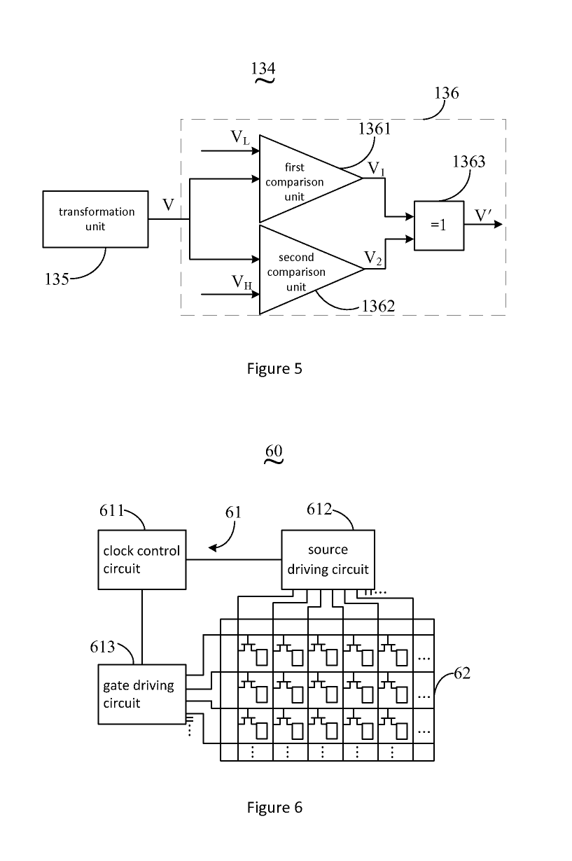

FIG. 5 is a schematic view showing the specific structure of the frequency detection module; and

FIG. 6 is a schematic view showing the structure of the liquid crystal display device of an embodiment according to the present invention.

### DETAILED DESCRIPTION OF THE PREFERRED EMBODIMENTS

Referring to FIG. 1, FIG. 1 is a schematic view showing the structure of a clock control circuit of an embodiment of the present invention. As shown in FIG. 1, a clock control circuit 10 comprises: an internal clock module 11, a signal receiving module 12, a detection module 13, a control module 14 and a selection module 15.

In the instant embodiment, the internal clock module 11 is configured to generate internal clock signal. The signal receiving module 12 is configured to receive external input signal and transmit the external input signal to the detection module 13. The detection module 13 is configured to determine whether the external input signal is a valid clock signal and transmit the determination to the control module 14. The control module 14 is configured to control the selection module 15 to select the external input signal for outputting when the determination from the detection module 13 is yes and to select the internal clock signal for outputting when the determination from the detection module 13 is no.

In the instant embodiment, the detection module 13 is a pulse width detection module. Specifically, referring to FIG. 2, FIG. 2 is a schematic view showing the structure of the detection module shown in FIG. 1. As shown in FIG. 2, the pulse width detection module 131 comprises a timing unit 132 and a comparison unit 133.

In the instant embodiment, the timing unit 132 is for measuring the interval T between two adjacent edges with the same direction in the external input signal. For example, the interval T can be the interval between two adjacent rising edges or between two falling edges. Specifically, when a rising edge or a falling edge occurs in the external input signal, the timing unit 132 starts to time, and when another rising edge or a falling edge occurs in the external input signal, the timing unit 132 stops timing. The interval T between the two adjacent rising or falling edges is computed and transmitted to the comparison unit 133.

The comparison unit 133 predefines a time threshold range and determines whether the interval T is within the time threshold range. When the result is yes, the control module 14 determines the external input signal is valid clock signal and controls the selection module 15 to select the external input signal for outputting. When the result is no, the control module 14 determines the external input signal is invalid clock signal and controls the selection module 15 to select the internal clock signal for outputting. Specifically, referring to FIG. 3, FIG. 3 is a schematic view showing the specific structure of the pulse width detection module. As shown in FIG. 3, the comparison unit 133 of the pulse width detection module 131 comprises a first comparison unit 1331, a second comparison unit 1332 and a logic operation unit 1333.

In the instant embodiment, the first comparison unit 1331 predefines a first boundary value TL of the time threshold range and compares the interval T from the timing unit 132 with the first boundary value TL to obtain a first comparison result T1 The second comparison unit 1332 predefines a second boundary value TH of the time threshold range and compares the interval. T from the timing unit 132 with the second boundary value TH to obtain a second comparison result T2.

It should be noted that the first boundary value TL is the shortest duration, and the second boundary value TH is the longest duration. The first boundary value TL and the second boundary value TH are both a multiple of the interval T between two adjacent falling/rising edges of the internal clock signal. When the interval T is greater than or equal to the first boundary value TL, the first comparison result T1 is at high level, indicated by 1; on the other hand, when the interval T is smaller than the first boundary value TL, the first comparison result T1 is at low level, indicated by 0. Similarly, when the interval T is greater than the second boundary value TH, the second comparison result T2 is at high level, indicated by 1; on the other hand, when the interval. T is smaller than or equal to the second boundary value TH, the second comparison result T2 is at low level, indicated by 0.

It should be understood that when the interval T is smaller than the first boundary value IL, the interval T is also smaller than the second boundary value TH. Therefore, the second comparison result T2 is also at low level, i.e., 0. Similarly, when the interval T is greater than the second boundary value TH, the interval T is also greater than the first boundary value TL. Therefore, the first comparison result T1 is also at high level, i.e., 1.

The logic operation unit 1333 performs logic operation on the first comparison result t1 and the second comparison result T2. Specifically, the logic operation unit 1333 of the instant embodiment is an XOR gate. In other words, when both the comparison result T1 and the second comparison result T2 are at the same level, the logic operation result T′ of the logic operation unit 1333 is at low level (0). When the comparison result T1 and the second comparison result T2 are at different levels, the logic operation result T′ of the logic operation unit 1333 is at high level (1). Specifically, referring to Table 1 as below, Table 1 shows relation of the interval T and the logic operation result T′:

TABLE 1

| T | T₁ | T₂ | T′ |
|---|---|---|---|
| T > T_{H} | 1 | 1 | 0 |
| T_{L} ≦ T ≦ T_{H} | 1 | 0 | 1 |
| T < T_{L} | 0 | 0 | 0 |

Based on the logic operation result T of the logic operation unit 1333, the control module 14 controls the selection module 15 to select either the external input signal or the internal clock signal for outputting. Specifically, when the logic operation result T′ is 1, the control module 14 determines the external input signal is valid clock signal and controls the selection module 15 to select the external input signal for outputting; when the logic operation result T′ is 0, the control module 14 determines the external input signal is invalid clock signal and controls the selection module 15 to select the internal clock signal for outputting.

In the instant embodiment, when the control module 14 controls the selection module 15 to select the internal clock signal for outputting, the clock control circuit 10 will generate a reset signal to reset the normalized bits of the internal clock module 11 to an initial state.

In other preferred embodiment, the logic operation unit can be an XNOR gate. When the logic operation result T′ is 1, the control module 14 determines the external input signal is invalid clock signal and controls the selection module 15 to select the internal clock signal for outputting; when the logic operation result T′ is 0, the control module 14 determines the external input signal is valid clock signal and controls the selection module 15 to select the external input signal for outputting.

In the present invention, the detection module 13 can also be a frequency detection module. Specifically, referring to FIG. 4, FIG. 4 is a schematic view showing another structure of the detection module shown in FIG. 1. As shown in FIG. 4, the detection module 13 is a frequency detection module 134, which comprises: a transformation unit 135 and a comparison unit 136.

In the instant embodiment, the transformation unit 135 is for transforming the frequency F of the external input signal into the voltage V of the external input signal by following the equation V=AF, wherein A is a constant. The transformation unit 135 also transmits the voltage V to the comparison unit 136.

The comparison unit 136 predefines a voltage threshold range and determines whether the voltage V is within the voltage threshold range. When the result is yes, the control module 14 determines the external input signal is valid clock signal and controls the selection module 15 to select the external input signal for outputting. When the result is no, the control module 14 determines the external input signal is invalid clock signal and controls the selection module 15 to select the internal clock signal for outputting. Specifically, referring to FIG. 5, FIG. 5 is a schematic view showing the specific structure of the frequency detection module. As shown in FIG. 5, the comparison unit 136 of the frequency detection module 134 comprises a first comparison unit 1361, a second comparison unit 1362 and a logic operation unit 1363.

In the instant embodiment, the first comparison unit 1361 predefines a first boundary value VL of the voltage threshold range and compares the voltage V with the first boundary value to obtain a first comparison result V1 The second comparison unit 1362 predefines a second boundary value VH of the voltage threshold range and compares the voltage V with the second boundary value VH to obtain a second comparison result V2.

It should be noted that the first boundary value VL is the voltage corresponding to the lowest frequency, and the second boundary value VH is the voltage corresponding to the highest frequency. When the voltage V is greater than or equal to the first boundary value VL, the first comparison result V1 is at high level, indicated by 1; on the other hand, when the voltage V is smaller than the first boundary value VL, the first comparison result V1 is at low level, indicated by 0. Similarly, when the voltage V is greater than the second boundary value VH, the second comparison result V2 is at high level, indicated by 1; on the other hand, when the voltage is smaller than or equal to the second boundary value VH, the second comparison result V2 is at low level, indicated by 0.

It should be understood that when the voltage V is smaller than the first boundary value VL, the voltage is also smaller than the second boundary value VH. Therefore, the second comparison result V2 is also at low level, i.e., 0. Similarly, when the voltage V is greater than the second boundary value VH, the voltage V is also greater than the first boundary value VL. Therefore, the first comparison result V1 is also at high level, i.e., 1.

The logic operation unit 1363 performs logic operation on the first comparison result V1 and the second comparison result V2. Specifically, the logic operation unit 1363 of the instant embodiment is an XOR gate. In other words, when both the comparison result V1 and the second comparison result V2 are at the same level, the logic operation result V′ of the logic operation unit 1363 is at low level (0). When the comparison result V1 and the second comparison result V2 are at different levels, the logic operation result V′ of the logic operation unit 1363 is at high level (1). Specifically, referring to Table 2 as below, Table 2 shows relation of the voltage V and the logic operation result V′:

TABLE 2

| V | V₁ | V₂ | V′ |
|---|---|---|---|
| V > V_{H} | 1 | 1 | 0 |
| V_{L} ≦ V ≦ V_{H} | 1 | 0 | 1 |
| V < V_{L} | 0 | 0 | 0 |

Based on the logic operation result V′ of the logic operation unit 1363, the control module 14 controls the selection module 15 to select either the external input signal or the internal clock signal for outputting. Specifically, when the logic operation result V′ is 1 the control module 14 determines the external input signal is valid clock signal and controls the selection module 15 to select the external input signal for outputting; when the logic operation result V′ is 0, the control module 14 determines the external input signal is invalid clock signal and controls the selection module 15 to select the internal clock signal for outputting.

In other preferred embodiment, the logic operation unit 1363 can be an XNOR gate. When the logic operation result V′ is 1, the control module 14 determines the external input signal is invalid clock signal and controls the selection module 15 to select the internal clock signal for outputting: when the logic operation result V′ is 0, the control module 14 determines the external input signal is valid clock signal and controls the selection module 15 to select the external input signal for outputting.

Referring to FIG. 6, FIG. 6 is a schematic view showing the structure of the liquid crystal display device of an embodiment according to the present invention. As shown in FIG. 6, a liquid crystal display device 60 comprises: a driving circuit 61 and a pixel array 62.

The driving circuit 61 further comprises: a clock control circuit 611, a source driving circuit 612 and a gate driving circuit 613.

In the instant embodiment, the clock control circuit 611 supplies clock signal to the source driving circuit 612 and the gate driving circuit 613, respectively. The source driving circuit 612 supplies a data signal to a pixel array 62 based on the clock signal; and the gate driving circuit 613 supplies a scan signal to the pixel array 62 based on the clock signal. Based on the data signal and scan signal supplied by the source driving circuit 612 and gate driving circuit 613, the pixel array 62 perform displaying of an image.

In summary, the clock control circuit of the present invention uses the signal receiving module to receive external input signal and transmits the external input signal to the detection module; the detection module determines whether the external input signal is valid clock signal and transmits the determination result to the control module; when the determination result is yes, the control module controls the selection module to select the external input signal for outputting, and when the determination result is no, the control module controls the selection module to select the internal clock signal for outputting. As such, the present invention first determines whether the external input signal is a valid clock signal when receiving the external input signal. When determined to be valid clock signal, the external input signal will be outputted; otherwise, the internal clock signal will be outputted. As a result, the present invention can avoid abnormal display when no external clock signal is inputted and the noise signal is mistaken as clock signal, so as to improve the displaying quality of the liquid crystal display device.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the claims of the present invention.

What is claimed is:

1. A clock control circuit, which comprises: an internal clock module, a signal receiving module, a selection module, a detection module and a control module, wherein:
the internal clock module being configured to generate internal clock signal;
the signal receiving module being configured to receive external input signal and transmit the external input signal to the detection module;
the detection module being configured to determine whether the external input signal being a valid clock signal and transmit the determination to the control module; and
the control module being configured to control the selection module to select the external input signal for outputting when the determination from the detection module being yes and to select the internal clock signal for outputting when the determination from the detection module being no.

2. The clock control circuit as claimed in claim 1, characterized in that the detection module is a pulse width detection module, which comprises a timing unit and a comparison unit; wherein:
the timing unit is for measuring the interval between two adjacent edges with the same direction in the external input signal; and
the comparison unit predefines a time threshold range and determines whether the interval is within the time threshold range; when the result is yes, the control module determines the external input signal is valid clock signal and controls the selection module to select the external input signal for outputting; when the result is no, the control module determines the external input signal is invalid clock signal and controls the selection module to select the internal clock signal for outputting.

3. The clock control circuit as claimed in claim 2, characterized in that the pulse width detection module comprises a first comparison unit, a second comparison unit and a logic operation unit; wherein:
the first comparison unit predefines a first boundary value of the time threshold range and compares the interval with the first boundary value to obtain a first comparison result;
the second comparison unit predefines a second boundary value of the time threshold range and compares the interval with the second boundary value to obtain a second comparison result; and
the logic operation unit performs logic operation on the first comparison result and the second comparison result:
based on the logic operation result of the logic operation unit, the control module controls the selection module to select either the external input signal or the internal clock signal for outputting.

4. The clock control circuit as claimed in claim 3, characterized in that when the logic operation result is 1, the control module determines the external input signal is valid clock signal and controls the selection module to select the external input signal for outputting; when the logic operation result is 0, the control module determines the external input signal is invalid clock signal and controls the selection module to select the internal clock signal for outputting; alternatively, when the logic operation result is 1, the control module determines the external input signal is invalid clock signal and controls the selection module to select the internal clock signal for outputting; when the logic operation result is 0, the control module determines the external input signal is valid clock signal and controls the selection module to select the external input signal for outputting.

5. The clock control circuit as claimed in claim 3, characterized in that the first boundary value and the second boundary value are both a multiple of the interval between two adjacent edges with the same direction of the internal clock signal.

6. The clock control circuit as claimed in claim 1, characterized in that the detection module is a frequency detection module, which comprises: a transformation unit and a comparison unit; wherein:
the transformation unit is for transforming the frequency of the external input signal into the voltage of the external input signal; and
the comparison unit predefines a voltage threshold range and determines whether the voltage is within the voltage threshold range; when the result is yes, the control module determines the external input signal is valid clock signal and controls the selection module to select the external input signal for outputting; when the result is no, the control module determines the external input signal is invalid clock signal and controls the selection module to select the internal clock signal for outputting.

7. The clock control circuit as claimed in claim 6, characterized in that the frequency detection module comprises a first comparison unit, a second comparison unit and a logic operation unit; wherein:
the first comparison unit predefines a first boundary value of the voltage threshold range and compares the voltage with the first boundary value to obtain a first comparison result;
the second comparison unit predefines a second boundary value of the voltage threshold range and compares the voltage with the second boundary value to obtain a second comparison result; and
the logic operation unit performs logic operation on the first comparison result and the second comparison result;
based on the logic operation result of the logic operation unit, the control module controls the selection module to select either the external input signal or the internal clock signal for outputting.

8. The clock control circuit as claimed in claim 7, characterized in that when the logic operation result is 1, the control module determines the external input signal is valid clock signal and controls the selection module to select the external input signal for outputting; when the logic operation result is 0, the control module determines the external input signal is invalid clock signal and controls the selection module to select the internal clock signal for outputting; alternatively, when the logic operation result is 1, the control module determines the external input signal is invalid clock signal and controls the selection module to select the internal clock signal for outputting; when the logic operation result is 0, the control module determines the external input signal is valid clock signal and controls the selection module to select the external input signal for outputting.

9. The clock control circuit as claimed in claim 1, characterized in that when the control module controls the selection module to select the internal clock signal for outputting, the clock control circuit generates a reset signal.

10. A driving circuit, which comprises: a source driving circuit, a gate driving circuit and a clock control circuit; wherein:
the clock control circuit supplying clock signal to the source driving circuit and the gate driving circuit respectively;
the source driving circuit supplying a data signal to a pixel array based on the clock signal;
the gate driving circuit supplying a scan signal to the pixel array based on the clock signal;
wherein the clock control circuit comprising: an internal clock module, a signal receiving module, a selection module, a detection module and a control module, wherein:
the internal clock module being configured to generate internal clock signal;
the signal receiving module being configured receive external input signal and transmit the external input signal to the detection module;
the detection module being configured to determine whether the external input signal being a valid clock signal and transmit the determination to the control module; and
the control module being configured to control the selection module to select the external input signal for outputting when the determination from the detection module being yes and to select the internal clock signal for outputting when the determination from the detection module being no.

11. The driving circuit as claimed in claim 10, characterized in that the detection module is a pulse width detection module, which comprises a timing unit and a comparison unit; wherein:
the timing unit is for measuring the interval between two adjacent edges with the same direction in the external input signal; and
the comparison unit predefines a time threshold range and determines whether the interval is within the time threshold range; when the result is yes, the control module determines the external input signal is valid clock signal and controls the selection module to select the external input signal for outputting; when the result is no, the control module determines the external input signal is invalid clock signal and controls the selection module to select the internal clock signal for outputting.

12. The driving circuit as claimed in claim 11, characterized in that characterized in that the pulse width detection module comprises a first comparison unit, a second comparison unit and a logic operation unit; wherein;
the first comparison unit predefines a first boundary value of the time threshold range and compares the interval with the first boundary value to obtain a first comparison result;
the second comparison unit predefines a second boundary value of the time threshold range and compares the interval with the second boundary value to obtain a second comparison result; and
the logic operation unit performs logic operation on the first comparison result and the second comparison result;
based on the logic operation result of the logic operation unit, the control module controls the selection module to select either the external input signal or the internal clock signal for outputting.

13. The driving circuit as claimed in claim 10, characterized in that the detection module is a frequency detection module, which comprises: a transformation unit and a comparison unit; wherein:
the transformation unit is for transforming the frequency of the external input signal into the voltage of the external input signal; and
the comparison unit predefines a voltage threshold range and determines whether the voltage is within the voltage threshold range; when the result is yes, the control module determines the external input signal is valid clock signal and controls the selection module to select the external input signal for outputting; when the result is no, the control module determines the external input signal is invalid clock signal and controls the selection module to select the internal clock signal for outputting.

14. The driving circuit as claimed in claim 13, characterized in that the frequency detection module comprises a first comparison unit, a second comparison unit and a logic operation unit; wherein:
the first comparison unit predefines a first boundary value of the voltage threshold range and compares the voltage with the first boundary value to obtain a first comparison result;
the second comparison unit predefines a second boundary value of the voltage threshold range and compares the voltage with the second boundary value to obtain a second comparison result; and
the logic operation unit performs logic operation on the first comparison result and the second comparison result;
based on the logic operation result of the logic operation unit, the control module controls the selection module to select either the external input signal or the internal clock signal for outputting.

15. A liquid crystal display device, which comprises: a pixel array and a driving circuit; the driving circuit further comprising: a source driving circuit, a gate driving circuit and a clock control circuit; wherein:
the clock control circuit supplying clock signal to the source driving circuit and the gate driving circuit respectively;
the source driving circuit supplying a data signal to a pixel array based on the clock signal;
the gate driving circuit supplying a scan signal to the pixel array based on the clock signal;
wherein the clock control circuit comprising: an internal clock module, a signal receiving module, a selection module, a detection module and a control module, wherein:
the internal clock module being configured to generate internal clock signal;
the signal receiving module being configured receive external input signal and transmit the external input signal to the detection module;
the detection module being configured to determine whether the external input signal being a valid clock signal and transmit the determination to the control module; and
the control module being configured to control the selection module to select the external input signal for outputting when the determination from the detection module being yes and to select the internal clock signal for outputting when the determination from the detection module being no.

16. The liquid crystal display device as claimed in claim 15, characterized in that the detection module is a pulse width detection module, which comprises a timing unit and a comparison unit; wherein:
the timing unit is for measuring the interval between two adjacent edges with the same direction in the external input signal; and
the comparison unit predefines a time threshold range and determines whether the interval is within the time threshold range; when the result is yes, the control module determines the external input signal is valid clock signal and controls the selection module to select the external input signal for outputting; when the result is no, the control module determines the external input signal is invalid clock signal and controls the selection module to select the internal clock signal for outputting.

17. The liquid crystal display device as claimed in claim 16, characterized in that characterized in that the pulse width detection module comprises a first comparison unit, a second comparison unit and a logic operation unit; wherein:
the first comparison unit predefines a first boundary value of the time threshold range and compares the interval with the first boundary value to obtain a first comparison result;
the second comparison unit predefines a second boundary value of the time threshold range and compares the interval with the second boundary value to obtain a second comparison result; and
the logic operation unit performs logic operation on the first comparison result and the second comparison result;
based on the logic operation result of the logic operation unit, the control module controls the selection module to select either the external input signal or the internal clock signal for outputting.

18. The liquid crystal display device as claimed in claim 15, characterized in that the detection module is a frequency detection module, which comprises: a transformation unit and a comparison unit; wherein:
the transformation unit is for transforming the frequency of the external input signal into the voltage of the external input signal; and
the comparison unit predefines a voltage threshold range and determines whether the voltage is within the voltage threshold range; when the result is yes, the control module determines the external input signal is valid clock signal and controls the selection module to select the external input signal for outputting; when the result is no, the control module determines the external input signal is invalid clock signal and controls the selection module to select the internal clock signal for outputting.

19. The liquid crystal display device as claimed in claim 18, characterized in that the frequency detection module comprises a first comparison unit, a second comparison unit and a logic operation unit; wherein:
the first comparison unit predefines a first boundary value of the voltage threshold range and compares the voltage with the first boundary value to obtain a first comparison result;
the second comparison unit predefines a second boundary value of the voltage threshold range and compares the voltage with the second boundary value to obtain a second comparison result; and
the logic operation unit performs logic operation on the first comparison result and the second comparison result;
based on the logic operation result of the logic operation unit, the control module controls the selection module to select either the external input signal or the internal clock signal for outputting.
